(19) United States
(12) Patent Application Publication
(10) Pub. No.: US 2010/0305294 A1
(43) Pub. Date: Dec. 2, 2010

(54) POLYURETHANE RESIN COMPOSITION FOR REACTION INJECTION MOLDING AND MOLDED ARTICLE

(75) Inventors: Hiroshi Kanayama, Chiba (JP); Yoshio Yoshida, Tokyo (JP); Hiroyuki Utsumi, Bangkok (TH); Satoshi Yamasaki, Chiba (JP)

Correspondence Address: FOLEY AND LARDNER LLP;SUITE 500, 3000 K STREET NW, WASHINGTON, DC, 20007, US

(73) Assignee: Mitsui Chemicals, Inc.

(21) Appl. No.: 12/744,976

(22) PCT Filed: Oct. 31, 2008
(86) PCT No.: PCT/JP2008/069921

§ 371 Date: May 27, 2010

(30) Foreign Application Priority Data
Nov. 28, 2007 (JP) 2007-307366

(51) Int. Cl. C08G 18/72

(52) U.S. Cl. 528/85

(57) ABSTRACT

Disclosed is a polyurethane resin composition for reaction injection molding, which contains an isocyanate component containing at least one of an alicyclic polyisocyanate and an aralkyl polyisocyanate and a trimer of hexamethylene diisocyanate, and a polyol component.

### TECHNICAL FIELD

The present invention relates to polyurethane resin compositions for reaction injection molding and molded articles thereof.

### BACKGROUND ART

Conventionally, thermosetting polyurethane resins molded by reaction injection molding have been excellent in long-term heat resistance and light fastness, and in use for various applications, for example, transportation equipment components such as automobile bumpers, dashboards, and door trims, which are exposed to high-temperature environment.

As for thermosetting polyurethane resins, there has been proposed a thermosetting polyurethane molded article that is molded by allowing an isocyanate component containing an isophorone diisocyanate (IPDI) trimer/monomer mixture (isocyanate group content: 24.5 to 34% by weight) and an isocyanate-reactive component containing a polyether polyol having terminal hydroxyl groups, an average functionality of 2 to 4, and an average equivalent weight of 800 to 4000; a chain extender having only aliphatic or alicyclic hydroxyl groups; and an amine initiator to react by reaction injection molding in a mold set to 80° C. or higher (see, for example, the following Patent Document 1).

Further, a thermosetting polyurethane molded article has been proposed that is molded by allowing (a) at least one kind of liquid polyisocyanate component selected from the group consisting of aliphatic polyisocyanates, alicyclic polyisocyanates, and mixtures thereof, (b) an isocyanate-reactive component having an average molecular weight of approximately 1000 to 6000 and an average functionality of two or more, and (c) an isocyanate-reactive component consisting of a polyhydroxyl compound having a molecular weight of less than 1000 based on a polyester ether polyol to react by reaction injection molding (see, for example, the following Patent Document 2).

Further, a thermosetting polyurethane molded article has been proposed that is obtained by molding mixing solution between a polyisocyanate component (A) containing at least a polycyclic aliphatic polyisocyanate (A-1) and an aliphatic polyisocyanate (A-2) so that the mixing ratio by weight thereof ((A-1)/(A-2)) is 20/80 to 80/20 and an active hydrogen compound (B) not substantially having an active hydrogen on an atom other than an oxygen atom by spraying process (see, for example, the following Patent Document 3).

Patent Document 1: Japanese Patent Gazette No. 3911030

Patent Document 2: Japanese Unexamined Patent Publication No. 9-3154

Patent Document 3: Japanese Unexamined Patent Publication No. 2004-224970

### DISCLOSURE OF THE INVENTION

### Problems to be Solved

However, since the isophorone diisocyanate trimer/monomer mixture that has poor reactivity is used for molding the thermosetting polyurethane molded article described in Patent Document 1 above, a lead catalyst which has a large environmental load is necessary to be added in a significant amount. In addition, since the mold temperature needs to be increased to 80° C. or higher, the production efficiency of the molded article is disadvantageously low.

Since the polyester ether polyol having high viscosity is used for molding the thermosetting polyurethane molded article described in Patent Document 2 above, the moldability of the molded article deteriorates.

Further, in the molding of the thermosetting polyurethane molded article described in Patent Document 3 above, it is necessary to lower the reactivity of the mixed solution in order to prevent clogging of the nozzle of the spraying device used in the spraying process. For this reason, the mold release time for the molded article becomes longer, which in turn deteriorates production efficiency.

It is an object of the present invention to provide a polyurethane resin composition for reaction injection molding capable of molding a molded article excellent in long-term heat resistance and light fastness with high production efficiency, and a molded article molded from the polyurethane resin composition for reaction injection molding.

### Means for Solving the Problem

To achieve the above object, the polyurethane resin composition for reaction injection molding of the present invention contains an isocyanate component comprising at least one of an alicyclic polyisocyanate and an aralkyl polyisocyanate and a trimer of hexamethylene diisocyanate; and a polyol component.

In the polyurethane resin composition for reaction injection molding of the present invention, it is preferable that a mixing ratio by weight of at least one of an alicyclic polyisocyanate and an aralkyl polyisocyanate to a trimer of hexamethylene diisocyanate is from 40:60 to 90:10.

In the polyurethane resin composition for reaction injection molding of the present invention, it is preferable that the alicyclic polyisocyanate and the aralkyl polyisocyanate are at least one kind selected from the group consisting of 1,3-bis(isocyanatomethyl)cyclohexane, 1,4-bis(isocyanatomethyl)cyclohexane, 2,5-di(isocyanatomethyl)bicyclo[2,2,1]heptane, 2,6-di(isocyanatomethyl)bicyclo[2,2,1]heptane, isophorone diisocyanate, 1,3-bis(isocyanatomethyl)benzene, and 1,4-bis(isocyanatomethyl)benzene.

In the polyurethane resin composition for reaction injection molding of the present invention, it is preferable that the isocyanate component is a polyol-modified polyisocyanate having an isocyanate group content of 20% by mass or more, which is modified with a polyol having a number average molecular weight of 100 to 10000.

The molded article of the present invention is molded from the polyurethane resin composition for reaction injection molding as described above.

### Effect of the Invention

According to the polyurethane resin composition for reaction injection molding of the present invention, a molded article excellent in mold releasability from a mold after the reaction injection molding, as well as excellent in long-term heat resistance and light fastness can be reaction injection molded with high production efficiency. For this reason, the molded article of the present invention is excellent in long-term heat resistance and light fastness. Therefore, the polyurethane resin composition for reaction injection molding of the present invention and a molded article thereof are useful in various fields involving reaction injection molding.

### EMBODIMENT OF THE INVENTION

The polyurethane resin composition for reaction injection molding of the present invention contains an isocyanate component and a polyol component.

In the present invention, the isocyanate component contains at least one of an alicyclic polyisocyanate and an aralkyl polyisocyanate, and a trimer of hexamethylene diisocyanate.

Examples of the alicyclic polyisocyanate include 1,3-cyclopentane diisocyanate, 1,4-cyclohexane diisocyanate, 1,3-cyclohexane diisocyanate, 3-isocyanatomethyl-3,5,5-trimethyl cyclohexylisocyanate, 4,4′-methylenebis(cyclohexylisocyanate), methyl-2,4-cyclohexane diisocyanate, methyl-2,6-cyclohexane diisocyanate, 1,3-bis(isocyanatomethyl)cyclohexane, 1,3-bis(isocyanatoethyl)cyclohexane, 1,4-bis(isocyanatomethyl)cyclohexane, 1,4-bis(isocyanatoethyl)cyclohexane, 2,6-di(isocyanatomethyl)bicyclo[2,2,1]heptane, and isophorone diisocyanate. Among them, 1,3-bis(isocyanatomethyl)cyclohexane, 1,4-bis(isocyanatomethyl)cyclohexane, 2,5-di(isocyanatomethyl)bicyclo[2,2,1]heptane, 2,6-di(isocyanatomethyl)bicyclo[2,2,1]heptane, and isophorone diisocyanate are preferable.

Examples of the aralkyl polyisocyanate include 1,3-bis(isocyanatomethyl)benzene, 1,4-bis(isocyanatomethyl)benzene, tetramethylxylylene diisocyanate, and ω,ω′-diisocyanato-1,4-diethylbenzene.

These polyisocyanates can be used alone and in combination of two or more kinds. Among them, 1,3-bis(isocyanatomethyl)cyclohexane and/or 1,4-bis(isocyanatomethyl)cyclohexane, 1,3-bis(isocyanatomethyl)benzene and/or 1,4-bis(isocyanatomethyl)benzene, and isophorone diisocyanate are preferable, or 1,3-bis(isocyanatomethyl)cyclohexane and/or 1,4-bis(isocyanatomethyl)cyclohexane, 1,3-bis(isocyanatomethyl)benzene and/or 1,4-bis(isocyanatomethyl)benzene are more preferable. Even more preferable is/are 1,3-bis(isocyanatomethyl)cyclohexane and/or 1,4-bis(isocyanatomethyl)cyclohexane.

1,4-bis(isocyanatomethyl)cyclohexane includes stereoisomers of cis-1,4-bis(isocyanatomethyl)cyclohexane (hereinafter referred to as cis-1,4 isomer) and trans-1,4-bis(isocyanatomethyl)cyclohexane (hereinafter referred to as trans-1,4 isomer), and in the present invention, 1,4-bis(isocyanatomethyl)cyclohexane contains trans-1,4 isomers in a proportion of preferably not less than 50% by weight, more preferably 70% by weight, or even more preferably not less than 80% by weight. Most preferably, it contains 90% by weight of trans-1,4 isomers.

Further, 1,3-bis(isocyanatomethyl)cyclohexane includes stereoisomers of cis-1,3-bis(isocyanatomethyl)cyclohexane (hereinafter referred to as cis-1,3 isomer) and trans-1,3-bis(isocyanatomethyl)cyclohexane (hereinafter referred to as trans-1,3 isomer), and in the present invention, 1,3-bis(isocyanatomethyl)cyclohexane contains trans-1,3 isomers in a proportion of preferably not less than 50% by weight, more preferably 70% by weight, or even more preferably not less than 90% by weight.

In the isocyanate component, the mixing ratio by weight of the alicyclic polyisocyanate and/or the aralkyl polyisocyanate to the trimer of hexamethylene diisocyanate is in the range of, for example, 40:60 to 90:10, preferably, 50:50 to 80:20, or more preferably 60:40 to 80:20.

When the mixing ratio by weight thereof is within the above range, the tear strength (tear resistance) of the polyurethane resin composition for reaction injection molding can be improved, so that it is possible to suppress breakage (e.g., tear) of the molded article at the time of releasing from the mold after the reaction injection molding. In addition, the long-term heat resistance of the molded article can also be improved.

The isocyanate component is prepared, for example, by blending the polyisocyanate as described above and the trimer of hexamethylene diisocyanate at the above-mentioned mixing ratio by weight, and then mixing them with stirring using a known stirrer.

The isocyanate component can also be prepared as a polyol-modified polyisocyanate (hereinafter simply referred to as a polyol-modified product in some cases) by modifying the polyisocyanate described above and the trimer of hexamethylene diisocyanate with a polyol.

Examples of the polyol include low and high molecular weight polyols which are described later. Among them, a low molecular weight polyol having a number average molecular weight of 100 to 400, and a high molecular weight polyol having a number average molecular weight of 400 to 10000 are preferable.

The polyol-modified polyisocyanate has an isocyanate group content of, for example, 20% by mass or more, preferably 21 to 30% by mass, or more preferably 23 to 28% by mass. When the isocyanate group content of the polyisocyanate is within the above range, the increase in the viscosity of the polyurethane resin composition for reaction injection molding can be suppressed, so that the deterioration of fluidity during the reaction injection molding can be suppressed.

When the isocyanate component is prepared as a polyol-modified product, for example, the polyisocyanate described above and the trimer of hexamethylene diisocyanate, and the polyol are blended at such a ratio that the molar ratio (isocyanate group/hydroxyl group) of the isocyanate groups of the polyisocyanate and the trimer of hexamethylene diisocyanate to the hydroxyl group of the polyol is in the range of, for example, 3 to 100, or preferably 5 to 50, and the mixture is allowed to react, for example, at 70 to 100° C. for 1 to 5 hours.

In the present invention, for example, a high molecular weight polyol is used as a polyol component.

The high molecular weight polyol is a compound having two or more hydroxyl groups in one molecule; a number average molecular weight of, for example, 400 to 10000, preferably 1400 to 7000, or more preferably 1500 to 5500; a hydroxyl value of, for example, 10 to 125 mgKOH/g; and an average functionality of, for example, 2 to 4. The number average molecular weight of the polyol component can be calculated from the hydroxyl value (obtained according to JIS K 1557-1 (2007)) and the average functionality of the polyol component.

Examples of the high molecular weight polyol include polyether polyol, polyester polyol, and polycarbonate polyol.

Examples of the polyether polyol include polyoxy (of 2 to 3 carbon atoms) alkylene polyol and polytetramethylene ether glycol.

The polyoxy (of 2 to 3 carbon atoms) alkylene polyol is an addition polymer of alkylene oxide which uses, for example, a low molecular weight polyol or a low molecular weight polyamine as an initiator.

Examples of the alkylene oxide include propylene oxide and ethylene oxide. These alkylene oxides can be used alone or in combination of two or more kinds.

As a catalyst for preparing the polyoxy (of 2 to 3 carbon atoms) alkylene polyol, for example, a phosphazenium compound described in Japanese Patent Gazette No. 3905638 may be used. When such catalyst is used to prepare a polyoxy (of 2 to 3 carbon atoms) alkylene polyol, a polyoxy (of 2 to 3 carbon atoms) alkylene polyol having a small amount of a monol by-product can be obtained.

The low molecular weight polyol is a compound having two or more hydroxyl groups and a number average molecular weight of 60 to less than 400, and examples thereof include dihydric alcohols such as ethylene glycol, propylene glycol, 1,3-propanediol, 1,4-butylene glycol, 1,3-butylene glycol, 1,2-butylene glycol, 1,5-pentanediol, 1,6-hexandiol, neopentyl glycol, alkane (7 to 22) diol, diethylene glycol, triethylene glycol, dipropylene glycol, 1,3- or 1,4-cyclohexane dimethanol and mixtures thereof, 1,4-cyclohexanediol, alkane-1,2-diol (C17-20), hydrogenated bisphenol F, hydrogenated bisphenol-A, 1,4-dihydroxy-2-butene, p-xylylene glycol, bis(2-hydroxyethyl)terephthalate, bis(2-hydroxyethyl)isophthalate, 1,4-bis(2-hydroxyethoxy)benzene, 1,3-bis(2-hydroxyethoxy)benzene, resorcinol, hydroquinone, 2,2′-bis(4-hydroxycyclohexyl)propane, 2,6-dimethyl-1-octene-3,8-diol, 3,9-bis(1,1-dimethyl-2-hydroxyethyl)-2,4,8,10-tetraoxaspiro[5,5]undecane, bisphenol F, and bisphenol A; trihydric alcohols such as glycerol and trimethylolpropane; polyhydric alcohols having four or more hydroxyl groups, such as tetramethylolmethane, pentaerythritol, dipentaerythritol, D-sorbitol, xylitol, D-mannitol, and D-mannite.

Examples of the low molecular weight polyamine include aliphatic diamine such as ethylenediamine; alkanolamines such as diethanolamine and triethanol; and aromatic diamine such as tolylenediamine.

Examples of the polyoxy (of 2 to 3 carbon atoms) alkylene polyol include polyethylene polyol, polypropylene polyol, and polyethylene-polypropylene polyol.

As the polyoxy (of 2 to 3 carbon atoms) alkylene polyol, polyethylene-polypropylene polyol in which ethylene oxide is copolymerized to the molecular end is preferable. In the polyethylene-polypropylene polyol, a primary hydroxyl group ratio at the molecular end (a ratio of the primary hydroxyl group to all the hydroxyl groups at the end of the molecule) is preferably not less than 50% by mole, or more preferably not less than 70% by mole. When the primary hydroxyl group ratio at the molecular end of the polyoxy (of 2 to 3 carbon atoms) alkylene polyol is not less than the above values, a reaction completion ratio to a polyisocyanate can be improved even with a small amount of the catalyst used.

The polyoxy (of 2 to 3 carbon atoms) alkylene polyol has a number average molecular weight of preferably 200 to 8000, or more preferably 500 to 6000.

Examples of the polytetramethylene ether glycol include a ring-opening polymerization product obtained by cationic polymerization of tetrahydrofuran, and amorphous (in liquid state at room temperature) polytetramethylene ether glycol obtained by copolymerizing the above-mentioned dihydric alcohol in a polymerization unit of tetrahydrofuran.

The polytetramethylene ether glycol has a number average molecular weight of preferably 250 to 8000, or more preferably 250 to 6000.

Examples of the polyester polyol include a polycondensation product obtained by allowing the above-mentioned low molecular weight polyol and a polybasic acid or alkylester thereof to react under known conditions.

Examples of the polybasic acid include carboxylic acids such as oxalic acid, malonic acid, succinic acid, methylsuccinic acid, glutaric acid, adipic acid, 1,1-dimethyl-1,3-dicarboxypropane, 3-methyl-3-ethyl glutaric acid, azelaic acid, sebacic acid, and other aliphatic dicarboxylic acids (of 11 to 13 carbon atoms), suberic acid, undecanedioic acid, dodecanedioic acid, tridecanedioic acid, tetradecanedioic acid, pentadecanedioic acid, octadecanedioic acid, nonadecanedioic acid, eicosanedioic acid, methylhexanedioic acid, citraconic acid, hydrogenated dimer acid, maleic acid, fumaric acid, itaconic acid, orthophthalic acid, isophthalic acid, terephthalic acid, toluene dicarboxylic acid, dimer acid, and HET acid; and acid anhydrides, acid halides and ricinoleic acids derived from these carboxylic acids, and 12-hydroxystearic acids.

Specifically, examples of the polycondensation product of the low molecular weight polyol and the polybasic acid include adipate polyester polyols such as poly(ethylene butylene adipate) polyol, poly(ethylene adipate) polyol, poly(ethylene propylene adipate) polyol, poly(propylene adipate) polyol, poly(butylene hexane adipate) polyol, and poly(butylene adipate) polyol; or poly(alkylene phthalate) polyol.

Examples of the polyester polyol include a castor oil polyol or an ester-modified castor oil polyol obtained by a reaction between a castor oil polyol and a polypropylene glycol.

Examples of the polyester polyol include polycaprolactone polyol and polyvalerolactone polyol, which are obtained by ring-opening polymerization of lactones, such as ε-caprolactone and γ-valerolactone, using the above-mentioned low molecular weight polyol as an initiator; and lactone-based polyol obtained by copolymerizing the above-mentioned dihydric alcohol thereto.

The polyester polyol has a number average molecular weight of preferably 500 to 8000, or more preferably 800 to 6000.

Examples of the polycarbonate polyol include a ring-opening polymerization product of ethylene carbonate using the above-mentioned dihydric alcohol as an initiator, or polycarbonate diol or amorphous (in liquid state at room temperature) polycarbonate polyol obtained by a condensation reaction between dihydric alcohol such as 1,3-propanediol, 1,4-butanediol, 1,5-pentanediol, or 1,6-hexandiol, and carbonate such as dimethyl carbonate, diethyl carbonate, or diphenyl carbonate.

The polycarbonate polyol has a number average molecular weight of preferably 500 to 8000, or more preferably 800 to 6000.

These high molecular weight polyols can be used alone or in combination of two or more kinds. Among them, a polyether polyol excellent in fluidity at low viscosity is preferable, a polyoxy (of 2 to 3 carbon atoms) alkylene polyol are more preferable, or a polyethylene polypropylene polyol is even more preferable.

In the present invention, the above-mentioned low molecular weight polyol can also be used as a polyol component together with the high molecular weight polyol.

The polyurethane resin composition for reaction injection molding of the present invention contains the above-mentioned isocyanate component and the above-mentioned polyol component, which are separately prepared or provided.

The polyurethane resin composition for reaction injection molding can be molded with a known reaction injection molding apparatus. The known reaction injection molding apparatus is, for example, an apparatus including at least (1) a first supply tank for supplying an isocyanate component, (2) a second supply tank for supplying a polyol component, (3) a mixing head for mixing the isocyanate component and the polyol component and then injecting the resulting mixture into a mold, and (4) a mold.

Specifically, first, the isocyanate component and the polyol component are supplied from the first supply tank (1) and the second supply tank (2), respectively, to the mixing head (3). At this time, the raw material temperature of the isocyanate component is adjusted to, for example, 35 to 55° C. On the other hand, the raw material temperature of the polyol component is adjusted to, for example, 35 to 55° C. During the mixing, the index (INDEX), which is represented by the molar ratio of the isocyanate group in the isocyanate component to the hydroxyl group in the polyol component in terms of percentage, is in the range of, for example, 80 to 120, and is preferably set to 95 to 105.

Then, the isocyanate component and the polyol component are mixed with stirring using the mixing head (3), and the resulting mixture is injected into the mold (4) at an injection rate of, for example, 200 to 2500 g/sec. The mold (4) is preliminarily pressurized at a pressure of, for example, 10 to 30 MPa and heated to a temperature of, for example, 60 to 80° C. Further, if necessary, a releasing agent such as an aqueous wax emulsion is applied to the molding surface of the mold (4) to improve the mold releasability of a molded article.

Then, the isocyanate component and the polyol component are injected into the mold (4), and thereafter, both of the components are subjected to polymerization in the mold (4), for example, for 1 to 3 minutes. Subsequently, the mold (4) is cooled to room temperature and the pressure therein is reduced to normal pressure, and the resulting molded article is released from the mold (4) to obtain a molded article.

In the present invention, if necessary, additives such as urethanizing catalyst, ultraviolet absorber, antioxidant, or multifunctional stabilizer can be added to either or both of the isocyanate component and the polyol component. These additives are preliminarily added to the isocyanate component and/or the polyol component. Preferably, they are added to the polyol component.

Examples of the urethanizing catalyst include metal catalysts and amine catalysts, and a metal catalyst is preferable.

Examples of the metal catalyst include tin or bismuth catalysts.

Examples of the tin catalyst include tin acetate, tin octanoate, tin oleate, tin laurate, stannous octoate, dibutyltin diacetate, dibutyltin dilaurate, dibutyltin dimercaptide, dibutyltin maleate, dimethyltin dilaurate, dioctyltin dimercaptide, and dimethyltin dineodecanoate.

Examples of the bismuth catalyst include bismuth neodecanoate.

The urethanizing catalysts can be used alone or in combination of two or more kinds. Among them, dimethyltin dilaurate, dibutyltin dilaurate, and dimethyltin dineodecanoate are preferable. The amount of the urethanizing catalyst added is in the range of, for example, 0.1 to 1.5 parts by mass, or preferably 0.3 to 1.0 part by mass, per 100 parts by mass of the polyol component.

Examples of the ultraviolet absorber include a benzophenone ultraviolet absorber, a benzotriazol ultraviolet absorber, a hindered amine ultraviolet absorber, a salicylate ultraviolet absorber, a cyanoacrylate ultraviolet absorber, an acrylonitrile ultraviolet absorber, a nickel or cobalt complex ultraviolet absorber. The ultraviolet absorbers can be used alone or in combination of two or more kinds. Among them, a benzotriazol ultraviolet absorber and a hindered amine ultraviolet absorber are preferable. The amount of the ultraviolet absorber added is in the range of, for example, 0.1 to 1.0 part by mass, or preferably 0.3 to 0.7 parts by mass, per 100 parts by mass of the polyol component.

Examples of the antioxidant include a hindered phenol stabilizer, an amine stabilizer, a phosphorus stabilizer, and a sulfur stabilizer. These antioxidants can be used alone or in combination of two or more kinds. Among them, a hindered phenol stabilizer is preferable. The amount of the antioxidant added is in the range of, for example, 0.1 to 1.0 part by mass, or preferably 0.3 to 0.7 parts by mass, per 100 parts by mass of the polyol component.

The multifunctional stabilizer is a stabilizer, for example, having both an ultraviolet absorption function and an antioxidant function, and specific examples thereof include a benzotriazolyl-alkyl bisphenol compound. The amount of the multifunctional stabilizer added is in the range of, for example, 0.1 to 1.0 part by mass, or preferably 0.3 to 0.7 parts by mass, per 100 parts by mass of the polyol component.

Further, depending on the applications, chain extender, crosslinking agent, pigment, flame retardant, pigment dispersing agent (wetting dispersing agent), foam stabilizer, or antifoaming agent can also be added to the mixture of the isocyanate component and the polyol component.

The molded article obtained as described above is excellent in long-term heat resistance and light fastness.

Specifically, the molded article has a gloss in the range of, for example, 0.5 to 2.5, or preferably 0.5 to 1.5 as determined according to JIS K7361-1 (1997) for long-term heat resistance.

The molded article has a difference ΔE between E values (before test: E1, after test: E2) in the range of, for example, 0.5 to 2.5, or preferably 0.5 to 1.5 as determined for light fastness using an automatic color difference meter before and after xenon irradiation test.

The molded article is also excellent in texture and has a Shore-A hardness in the range of, for example, 50 to 90, or preferably 70 to 90 as determined according to the testing method for vulcanized rubber described in JIS K6301 (1969). It also has an elongation in the range of 80 to 400%, or preferably 100 to 300% as determined according to the testing method for vulcanized rubber described in JIS K6301 (1969).

Further, the molded article has a tear resistance in the range of, for example, 10 to 70 N/mm, or preferably 20 to 70 N/mm as determined according to the testing method for vulcanized rubber described in JIS K6301 (1969).

For this reason, the molded article of the present invention can be molded using a low-temperature mold with good mold releasability. In addition, as described above, it is excellent in physical properties such as long-term heat resistance and light fastness.

Therefore, the molded article of the present invention can be preferably used in various fields involving reaction injection molding, for example, transportation equipment components such as automobile bumpers, dashboards, door trims, and instrument panels; interior parts of stores, offices, and other buildings; and home and office furniture. In particular, it can be preferably used in skin layers of interior decorative materials in transportation equipment, such as automobile instrument panels and door trims, which are exposed to high-temperature environment.

### EXAMPLES

While in the following, the present invention is described with reference to Examples and Comparative Examples, the present invention is not limited to any of them. In the following description, the units “part(s)” and “%” are by mass, unless otherwise noted.

<Raw Materials>

The following raw materials were used.

1,3-BIC (1)

1,3-bis(isocyanatomethyl)cyclohexane (TAKENATE 600 available from Mitsui Chemicals Polyurethanes, Inc.)

1,4-BIC (2)

Prepared by a cold/hot two-stage phosgenation process under normal pressure using 1,4-bis(aminomethyl)cyclohexane (available from Mitsubishi Gas Chemical Company, Inc.) having a trans/cis ratio of 93/7 determined by ¹³C-NMR as a raw material.

Specifically, a stirring rod, a thermometer, a phosgene inlet tube, a dropping funnel, and a condenser tube were attached to a flask, and the flask was charged with 400 parts by mass of ortho dichlorobenzene. While the flask was cooled with cold water, the temperature in the flask was lowered to 10° C. or below, and 280 parts by mass of phosgene was introduced thereinto from the phosgene inlet tube. The dropping funnel was charged with a mixed solution of 100 parts by mass of 1,4-bis(aminomethyl)cyclohexane and 500 parts by mass of ortho dichlorobenzene, and the mixed solution was added into the flask over 30 minutes. During this time, the temperature in the flask was maintained at 30° C. or below. After completion of the addition, a white slurry-like liquid was formed in the flask. Again, the reaction temperature was increased to 150° C. with introducing phosgene, and the reaction was continued at 150° C. for 5 hours. The reaction solution in the flask became a pale-brown transparent liquid.

After completion of the reaction, nitrogen gas was purged at a temperature of 100 to 150° C. at a flow rate of 10 L/hour for degassing.

The ortho dichlorobenzene solvent was distilled away under reduced pressure and a fraction having a boiling point of 138 to 140° C./0.7 KPa was further sampled by vacuum distillation.

Thus, 123 parts by mass (90% yield) of 1,4-bis(isocyanatomethyl)cyclohexane was obtained in the form of a colorless and transparent liquid.

The resulting 1,4-bis(isocyanatomethyl)cyclohexane had a purity, which was determined by gas chromatography, of 99.9%, a hue of 5 in APHA, and a trans/cis ratio, which was determined by ¹³C-NMR, of 93/7.

IPDI (3)

Isophorone diisocyanate (VESTANAT IPDI available from Degussa Corporation)

1,3-XDI (4)

m-xylylene diisocyanate (TAKENATE 500 available from Mitsui Chemicals Polyurethanes, Inc.)

HDI (5)

Hexamethylene diisocyanate (TAKENATE 700 available from Mitsui Chemicals Polyurethanes, Inc.)

Crude MDI (6)

Diphenylmethane diisocyanate (Cosmonate M-50 available from Mitsui Chemicals Polyurethanes, Inc.)

HDI trimer (7)

Hexamethylene diisocyanate trimer (TAKENATE D170N available from Mitsui Chemicals Polyurethanes, Inc.)

IPDI trimer (8)

Isophorone diisocyanate trimer (VESTANAT 1890/100 available from Degussa Corporation)

Polyol-Modified Product (9)

A urethane-modified product (isocyanate group content: 26% by weight) in which isocyanates containing 1,3-BIC (1) and HDI trimer (7) at a mixing weight ratio of 70/30 were partially modified with TPG (20) described later.

More specifically, the following method was used to prepare a polyol-modified product (9). Charged were 70 parts by mass of 1,3-BIC (1), 30 parts by mass of HDI trimer (7), and 14.6 parts by mass of TPG (20) described later, and allowed to react at 90° C. for 5 hours to produce a polyol-modified product (9).

Polyol-Modified Product (10)

A urethane-modified product (isocyanate group content: 23% by weight) in which isocyanates containing 1,3-BIC (1) and HDI trimer (7) at a mixing weight ratio of 70/30 were partially modified with TPG (20) described later. More specifically, the following method was used to prepare a polyol-modified product (10). Charged were 70 parts by mass of 1,3-BIC (1), 30 parts by mass of HDI trimer (7), and 20.0 parts by mass of TPG (20) described later, and allowed to react at 90° C. for 5 hours to produce a polyol-modified product (10).

Polyol-Modified Product (11)

A urethane-modified product (isocyanate group content: 21% by weight) in which isocyanates containing 1,3-BIC (1) and HDI trimer (7) at a mixing weight ratio of 70/30 were partially modified with TPG (20) described later.

More specifically, the following method was used to prepare a polyol-modified product (11). Charged were 70 parts by mass of 1,3-BIC (1), 30 parts by mass of HDI trimer (7), and 23.8 parts by mass of TPG (20) described later, and allowed to react at 90° C. for 5 hours to produce a polyol-modified product (11).

Polyol-Modified Product (12)

A urethane-modified product (isocyanate group content: 26% by weight) in which isocyanates containing 1,3-BIC (1), IPDI (3), and HDI trimer (7) at a mixing weight ratio of 60/10//30 were partially modified with TPG (20) described later.

More specifically, the following method was used to prepare a polyol-modified product (12). Charged were 60 parts by mass of 1,3-BIC (1), 10 parts by mass of IPDI (3), 30 parts by mass of HDI trimer (7), and 14.1 parts by mass of TPG (20) described later, and allowed to react at 90° C. for 5 hours to produce a polyol-modified product (12).

Polyol-Modified Product (13)

A urethane-modified product (isocyanate group content: 28% by weight) in which isocyanates containing IPDI (3) and IPDI trimer (8) at a mixing weight ratio of 63/37 were partially modified with polyether polyol (14) described later.

More specifically, the following method was used to prepare a polyol-modified product (13). Charged were 63 parts by mass of IPDI (3), 37 parts by mass of IPDI trimer (8), and 7.6 parts by mass of polyether polyol (14) described later, and allowed to react at 90° C. for 5 hours to produce a polyol-modified product (13).

Polyether Polyol (14)

Polyether polyol having an average functionality of 3, a hydroxyl value of 34 mgKOH/g, and a total degree of unsaturation of 0.017 meq./g, which was obtained by addition-polymerizing propylene oxide to glycerol using a phosphazenium compound described in Japanese Patent Gazette No. 3905638 as a catalyst, and then addition-polymerizing ethylene oxide thereto.

The propylene oxide and the ethylene oxide were addition-copolymerized to glycerol at a weight ratio of propylene oxide/ethylene oxide of 86/14, in which the ethylene oxide is copolymerized to the molecular end.

1,4-BD (15)

1,4-butanediol (1,4-BG available from Mitsubishi Chemical Corporation)

Ultraviolet Absorber (16)

SANOL LS770 available from Sankyo Co., Ltd. (hindered amine ultraviolet absorber)

Antioxidant (17)

IRGANOX1035 available from Ciba Specialty Chemicals (hindered phenolic antioxidant)

Multifunctional Stabilizer (18)

JAST-500 available from Johoku Chemical Co., Ltd. (benzotriazol stabilizer)

Urethanizing Catalyst (19)

Dimethyltin dineodecanoate (UL-28 available from GE silicone)

TPG (20)

Tripropylene glycol (TPG-H available from ADEKA Corporation)

### Example 1

### (1) Preparation of Isocyanate Component

A reactor was charged with 70 parts by mass of 1,3-BIC (1) and 30 parts by mass of HDI trimer (7), and the charged mixture was mixed with stirring and subjected to deaeration. This produces an isocyanate component.

### (2) Preparation of Polyol Component

To a reactor was added 100 parts by mass of polyether polyol (14), 0.5 parts by mass of ultraviolet absorber (16), and 0.5 parts by mass of antioxidant (17), and 0.5 parts by mass of multifunctional stabilizer (18), and the mixture was dissolved at 90° C. Subsequently, 35 parts by mass of 1,4-BD (15) and 0.5 parts by mass of urethanizing catalyst (19) were added, and the charged mixture was mixed with stirring and subjected to deaeration. The resulting product was cooled to 60° C. to obtain a polyol component.

### (3) Molding of Molded Article

The polyurethane resin composition for reaction injection molding, i.e., the isocyanate component obtained at step (1) and the polyol component obtained at step (2) were mixed in a mixing head of a two-component type high-pressure foaming machine fixed to a mold, injected from a gate into an aluminum test mold, and released from the test mold at a time when a molded article was allowed to be released, i.e., the mold release time shown in Table 2, to thereby produce a molded article (1). The blending ratio (INDEX) of the isocyanate component and the polyol component is shown in Table 1.

The molding conditions are as follows. An aqueous wax emulsion type releasing agent was preliminarily applied to the molding surface of the mold.

Injection rate: 400 g/sec

Isocyanate component raw material temperature: 45° C.

Polyol component raw material temperature: 45° C.

Mold size: 460×380×1 mm

Mold temperature: 70° C.

### Example 2

A molded article (2) was produced by the same conditions and operation as in Example 1 except that 70 parts by mass of 1,4-BIC (2) and 30 parts by mass of HDI trimer (7) were used for the isocyanate component. The blending ratio (INDEX) of the isocyanate component and the polyol component is shown in Table 1.

### Example 3

A molded article (3) was produced by the same conditions and operation as in Example 1 except that 90 parts by mass of 1,3-BIC (1) and 10 parts by mass of HDI trimer (7) were used for the isocyanate component. The blending ratio (INDEX) of the isocyanate component and the polyol component is shown in Table 1.

### Example 4

A molded article (4) was produced by the same conditions and operation as in Example 1 except that 50 parts by mass of 1,3-BIC (1) and 50 parts by mass of HDI trimer (7) were used for the isocyanate component. The blending ratio (INDEX) of the isocyanate component and the polyol component is shown in Table 1.

### Example 5

A molded article (5) was produced by the same conditions and operation as in Example 1 except that 100 parts by mass of polyol-modified product (9) was used for the isocyanate component. The blending ratio (INDEX) of the isocyanate component and the polyol component is shown in Table 1.

### Example 6

A molded article (6) was produced by the same conditions and operation as in Example 1 except that 100 parts by mass of polyol-modified product (12) was used for the isocyanate component. The blending ratio (INDEX) of the isocyanate component and the polyol component is shown in Table 1.

### Example 7

A molded article (7) was produced by the same conditions and operation as in Example 1 except that 100 parts by mass of polyol-modified product (10) was used for the isocyanate component. The blending ratio (INDEX) of the isocyanate component and the polyol component is shown in Table 1.

### Example 8

A molded article (8) was produced by the same conditions and operation as in Example 1 except that 95 parts by mass of 1,3-BIC (1) and 5 parts by mass of HDI trimer (7) were used for the isocyanate component. The blending ratio (INDEX) of the isocyanate component and the polyol component is shown in Table 1.

### Example 9

A molded article (9) was produced by the same conditions and operation as in Example 1 except that 40 parts by mass of 1,3-BIC (1) and 60 parts by mass of HDI trimer (7) were used for the isocyanate component. The blending ratio (INDEX) of the isocyanate component and the polyol component is shown in Table 1.

### Example 10

A molded article (10) was produced by the same conditions and operation as in Example 1 except that 100 parts by mass of polyol-modified product (11) was used for the isocyanate component. The blending ratio (INDEX) of the isocyanate component and the polyol component is shown in Table 1.

### Example 11

A molded article (11) was produced by the same conditions and operation as in Example 1 except that 70 parts by mass of IPDI (3) and 30 parts by mass of HDI trimer (7) were used for the isocyanate component. The blending ratio (INDEX) of the isocyanate component and the polyol component is shown in Table 1.

### Example 12

A molded article (12) was produced by the same conditions and operation as in Example 1 except that 70 parts by mass of 1,3-XDI (4) and 30 parts by mass of HDI trimer (7) were used for the isocyanate component. The blending ratio (INDEX) of the isocyanate component and the polyol component is shown in Table 1.

### Comparative Example 1

A molded article (13) was produced by the same conditions and operation as in Example 1 except that 55 parts by mass of 1,3-BIC (1) and 45 parts by mass of 1,4-BIC (2) were used for the isocyanate component. The blending ratio (INDEX) of the isocyanate component and the polyol component is shown in Table 1.

### Comparative Example 2

A molded article (14) was produced by the same conditions and operation as in Example 1 except that 100 parts by mass of polyol-modified product (13) was used for the isocyanate component. The blending ratio (INDEX) of the isocyanate component and the polyol component is shown in Table 1.

### Comparative Example 3

A molded article (15) was produced by the same conditions and operation as in Example 1 except that 100 parts by mass of HDI trimer (7) was used for the isocyanate component. The blending ratio (INDEX) of the isocyanate component and the polyol component is shown in Table 1.

### Comparative Example 4

A molded article (16) was produced by the same conditions and operation as in Example 1 except that 70 parts by mass of HDI (5) and 30 parts by mass of HDI trimer (7) were used for the isocyanate component. The blending ratio (INDEX) of the isocyanate component and the polyol component is shown in Table 1.

### Comparative Example 5

A molded article (17) was produced by the same conditions and operation as in Example 1 except that 70 parts by mass of crude MDI (6) and 30 parts by mass of HDI trimer (7) were used for the isocyanate component. The blending ratio (INDEX) of the isocyanate component and the polyol component is shown in Table 1.

### Comparative Example 6

A molded article (18) was produced by the same conditions and operation as in Example 1 except that 70 parts by mass of 1,3-BIC (1) and 30 parts by mass of IPDI trimer (8) were used for the isocyanate component. The blending ratio (INDEX) of the isocyanate component and the polyol component is shown in Table 1.

TABLE 1

| | | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|---|
| Isocyanate | 1,3-BIC (1) | 70 | | 90 | 50 | | | | 95 | 40 | |
| Component | 1,4-BIC (2) | | 70 | | | | | | | | |
| | IPDI (3) | | | | | | | | | | |
| | 1,3-XDI (4) | | | | | | | | | | |
| | HDI (5) | | | | | | | | | | |
| | Crude MDI (6) | | | | | | | | | | |
| | HDI Trimer (7) | 30 | 30 | 10 | 50 | | | | 5 | 60 | |
| | IPDI Trimer (8) | | | | | | | | | | |
| | Polyol-Modified Product (9) | | | | | 100 | | | | | |
| | (1,4-BIC(1)/HDI trimer(7)/TPG) | | | | | | | | | | |
| | (70/30/14.6) | | | | | | | | | | |
| | Polyol-Modified Product (10) | | | | | | | 100 | | | |
| | (1,4-BIC(1)/HDI trimer(7)/TPG) | | | | | | | | | | |
| | (70/30/20.0) | | | | | | | | | | |
| | Polyol-Modified Product (11) | | | | | | | | | | 100 |
| | (1,4-BIC(1)/HDI trimer(7)/TPG) | | | | | | | | | | |
| | (70/30/23.8) | | | | | | | | | | |
| | Polyol-Modified Product (12) | | | | | | 100 | | | | |
| | (1,4-BIC(1)/IPDI(3)/HDI | | | | | | | | | | |
| | trimer(7)/TPG) | | | | | | | | | | |
| | (60/10/30/14.1) | | | | | | | | | | |
| | Polyol-Modified Product (13) | | | | | | | | | | |
| | (IPDI(3)/IPDI trimer(8)/Polyether | | | | | | | | | | |
| | Polyol(14) (63/37/7.6) | | | | | | | | | | |
| Polyol | Polyether Plyol (14) | 100 | 100 | 100 | 100 | 100 | 100 | 100 | 100 | 100 | 100 |
| Component | 1,4-BD (15) | 35 | 35 | 35 | 35 | 35 | 35 | 35 | 35 | 35 | 35 |
| | Ultraviolet Absorber (16) | 0.5 | 0.5 | 0.5 | 0.5 | 0.5 | 0.5 | 0.5 | 0.5 | 0.5 | 0.5 |
| | Antioxidant (17) | 0.5 | 0.5 | 0.5 | 0.5 | 0.5 | 0.5 | 0.5 | 0.5 | 0.5 | 0.5 |
| | Multifunctional Stabilizer (18) | 0.5 | 0.5 | 0.5 | 0.5 | 0.5 | 0.5 | 0.5 | 0.5 | 0.5 | 0.5 |
| | Urethanizing Catalyst (19) | 0.5 | 0.5 | 0.5 | 0.5 | 0.5 | 0.5 | 0.5 | 0.5 | 0.5 | 0.5 |

| | | | | | | | | | | |
|---|---|---|---|---|---|---|---|---|---|---|
| INDEX | 100 | 100 | 100 | 100 | 100 | 100 | 100 | 100 | 100 | 100 |

| | | | | Comp. | Comp. | Comp. | Comp. | Comp. | Comp. |
|---|---|---|---|---|---|---|---|---|---|
| | | Ex. 11 | Ex. 12 | Ex. 1 | Ex. 2 | Ex. 3 | Ex. 4 | Ex. 5 | Ex. 6 |
| Isocyanate | 1,3-BIC (1) | | | 55 | | | | | 70 |
| Component | 1,4-BIC (2) | | | 45 | | | | | |
| | IPDI (3) | 70 | | | | | | | |
| | 1,3-XDI (4) | | 70 | | | | | | |
| | HDI (5) | | | | | | 70 | | |
| | Crude MDI (6) | | | | | | | 70 | |
| | HDI Trimer (7) | 30 | 30 | | | 100 | 30 | 30 | |
| | IPDI Trimer (8) | | | | | | | | 30 |
| | Polyol-Modified Product (9) | | | | | | | | |
| | (1,4-BIC(1)/HDI trimer(7)/TPG) | | | | | | | | |
| | (70/30/14.6) | | | | | | | | |
| | Polyol-Modified Product (10) | | | | | | | | |
| | (1,4-BIC(1)/HDI trimer(7)/TPG) | | | | | | | | |
| | (70/30/20.0) | | | | | | | | |
| | Polyol-Modified Product (11) | | | | | | | | |
| | (1,4-BIC(1)/HDI trimer(7)/TPG) | | | | | | | | |
| | (70/30/23.8) | | | | | | | | |
| | Polyol-Modified Product (12) | | | | | | | | |
| | (1,4-BIC(1)/IPDI(3)/HDI | | | | | | | | |
| | trimer(7)/TPG) | | | | | | | | |
| | (60/10/30/14.1) | | | | | | | | |
| | Polyol-Modified Product (13) | | | | 100 | | | | |
| | (IPDI(3)/IPDI trimer(8)/Polyether | | | | | | | | |
| | Polyol(14) (63/37/7.6) | | | | | | | | |
| Polyol | Polyether Plyol (14) | 100 | 100 | 100 | 100 | 100 | 100 | 100 | 100 |
| Component | 1,4-BD (15) | 35 | 35 | 35 | 35 | 35 | 35 | 35 | 35 |
| | Ultraviolet Absorber (16) | 0.5 | 0.5 | 0.5 | 0.5 | 0.5 | 0.5 | 0.5 | 0.5 |
| | Antioxidant (17) | 0.5 | 0.5 | 0.5 | 0.5 | 0.5 | 0.5 | 0.5 | 0.5 |
| | Multifunctional Stabilizer (18) | 0.5 | 0.5 | 0.5 | 0.5 | 0.5 | 0.5 | 0.5 | 0.5 |
| | Urethanizing Catalyst (19) | 0.5 | 0.5 | 0.5 | 0.5 | 0.5 | 0.5 | 0.5 | 0.5 |

| | | | | | | | | |
|---|---|---|---|---|---|---|---|---|
| INDEX | 100 | 100 | 100 | 100 | 100 | 100 | 100 | 100 |

### Evaluation of Physical Properties

### <Mold Release Time (Unit: Second)>

A catalyst was added to a mixed solution of the isocyanate component and the polyol component obtained by mixing them at the same blending ratio as in each of Examples and Comparative Examples, and a time from the start of pressure reduction and stirring until the gelated polyurethane resin was allowed to be released from the mold was measured. The measured time was referred to as a mold release time (DT) in each of Examples and Comparative Examples. The results are shown in Table 2.

The following methods were used to measure the Shore-A hardness, elongation, tear resistance, gloss, viscosity, light fastness, and presence/absence of odor of the molded article obtained in each of Examples and Comparative Examples (hereinafter abbreviated as each molded article). The results are shown in Table 2.

### <Shore-A Hardness>

The Shore-A hardness of each molded article was measured according to the testing method for vulcanized rubber described in JIS K6301 (1969). The results are shown in Table 2.

### <Elongation (Unit: %)>

A tensile test was conducted according to the testing method for vulcanized rubber described in JIS K6301 (1969) and the elongation (EL) of each molded article was measured. The results are shown in Table 2.

### <Tear Resistance (Unit: N/mm)>

According to the testing method for vulcanized rubber described in JIS K6301 (1969), a tear test was conducted to measure the tear resistance (TR-B) of each molded article. The results are shown in Table 2.

### <Degree of Gloss>

A 30 mm×50 mm×1 mm test piece was made using each molded article. The test piece was placed on a shelf in an oven under air atmosphere at 110° C., and the degrees of gloss before heating and 1000 hours after the start of heating were measured according to JIS K 7361-1 (1997). It was judged that the lower the degree of gloss was, the better the heat resistance was. The results are shown in Table 2.

<Viscosity (Unit: mPa·s)>

According to the testing method for vulcanized rubber described in JIS K7117-1, the viscosity of each molded article at 25° C. was measured using a B-type viscometer. The results are shown in Table 2.

### <Light Fastness (ΔE)>

An irradiation test using a xenon lamp was conducted after an E value (E1) of each strip-shaped molded article was measured using an automatic color difference meter (COLOR ACE TC-1 available from Tokyo Denshoku Co., Ltd.).

After the test, an E value (E2) of the composition was measured, and a difference (ΔE=|E2−E1|) between the E values before and after the xenon lamp irradiation test was calculated. It was judged that the smaller the ΔE was, the better the light fastness was. The results are shown in Table 2.

The xenon lamp irradiation test was conducted using a xenon weather meter (model: SX75, available from Suga Test Instruments Co., Ltd.), until the light exposure reaches 150 MJ on the conditions of a black panel temperature of 83° C., a relative humidity of 50% RH, and a xenon lamp radiant intensity of 150 W/m².

### <Odor>

The polyurethane resin composition for reaction injection molding was mixed in a mixing head of a two-component type high-pressure foaming machine fixed to a mold, and was injected from a gate into an aluminum test mold. Subsequently, a sensory evaluation was performed within a 2-m radius of the working area around the mold until a molded article was produced after unmolding, and the case where the odor of polyisocyanate was hardly sensed was designated as “absent” and the case where the odor thereof was strongly sensed was designated as “present”.

TABLE 2

| | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| Mold Release Time (sec) | 60 | 50 | 80 | 50 | 60 | 70 | 85 | 90 | 50 | 90 |
| Shore A Hardness | 77 | 92 | 70 | 80 | 82 | 76 | 82 | 68 | 80 | 80 |
| Elongation (%) | 205 | 119 | 316 | 168 | 238 | 238 | 248 | 383 | 110 | 200 |
| Tear Resistance (N/mm) | 37.5 | 62.3 | 37.4 | 24.8 | 37.3 | 28.4 | 37.4 | 40.3 | 21.5 | 35.2 |
| Degree of Gloss | 0.3 | 0.1 | 1.8 | 0.1 | 0.3 | 0.1 | 1.1 | 2.3 | 0.4 | 1.8 |
| Viscosity (mPa · s) | 35 | 35 | 35 | 100 | 500 | 500 | 3000 | 8 | 200 | 5000 |
| Light Fastness (ΔE) | 0.7 | 0.3 | 1.5 | 0.3 | 0.5 | 0.5 | 1.5 | 2.1 | 0.8 | 1.8 |
| Odor | Absent | Absent | Absent | Absent | Absent | Absent | Absent | Absent | Absent | Absent |

| | | | Comp. | Comp. | Comp. | Comp. | Comp. | Comp. |
|---|---|---|---|---|---|---|---|---|
| | Ex. 11 | Ex. 12 | Ex. 1 | Ex. 2 | Ex. 3 | Ex. 4 | Ex. 5 | Ex. 6 |
| Mold Release Time (sec) | 120 | 50 | 120 | 180 | 50 | 40 | 120 | 150 |
| Shore A Hardness | 85 | 65 | 83 | 94 | 76 | 91 | 92 | 80 |
| Elongation (%) | 224 | 225 | 286 | 287 | 33 | 162 | 85 | 209 |
| Tear Resistance (N/mm) | 35.0 | 20.0 | 71.0 | 71.7 | 4.0 | 62.4 | 37.0 | 43.0 |
| Degree of Gloss | 0.9 | 0.8 | 51.5 | 0.5 | 0.5 | 0.6 | 0.7 | 0.7 |
| Viscosity (mPa · s) | 40 | 30 | 500 | 2500 | 2700 | 10 | 150 | 100 |
| Light Fastness (ΔE) | 1.0 | 1.1 | 8.3 | 0.9 | 0.9 | 1.0 | 12.3 | 1.2 |
| Odor | Absent | Absent | Absent | Absent | Absent | Present | Absent | Absent |

While the illustrative embodiments of the present invention are provided in the above description, such is for illustrative purpose only and it is not to be construed restrictively. Modification and variation of the present invention that will be obvious to those skilled in the art is to be covered by the following claims.

### INDUSTRIAL APPLICABILITY

The polyurethane resin composition for reaction injection molding of the present invention is suitably used for reaction injection molding.

1. A polyurethane resin composition for reaction injection molding comprising:
an isocyanate component comprising at least one of an alicyclic polyisocyanate and an aralkyl polyisocyanate and a trimer of hexamethylene diisocyanate; and
a polyol component.

2. The polyurethane resin composition for reaction injection molding according to claim 1, wherein a mixing ratio by weight of at least one of an alicyclic polyisocyanate and an aralkyl polyisocyanate to a trimer of hexamethylene diisocyanate is from 40:60 to 90:10.

3. The polyurethane resin composition for reaction injection molding according to claim 1, wherein the alicyclic polyisocyanate and the aralkyl polyisocyanate are at least one kind selected from the group consisting of 1,3-bis(isocyanatomethyl)cyclohexane, 1,4-bis(isocyanatomethyl)cyclohexane, 2,5-di(isocyanatomethyl)bicyclo[2,2,1]heptane, 2,6-di(isocyanatomethyl)bicyclo[2,2,1]heptane, isophorone diisocyanate, 1,3-bis(isocyanatomethyl)benzene, and 1,4-bis(isocyanatomethyl)benzene.

4. The polyurethane resin composition for reaction injection molding according to claim 1, wherein the isocyanate component is a polyol-modified polyisocyanate having an isocyanate group content of 20% by mass or more, which is modified with a polyol having a number average molecular weight of 100 to 10000.

5. A molded article molded from a polyurethane resin composition for reaction injection molding comprising:
an isocyanate component comprising at least one of an alicyclic polyisocyanate and an aralkyl polyisocyanate and a trimer of hexamethylene diisocyanate; and
a polyol component.
